(19) United States
(12) Patent Application Publication
(10) Pub. No.: US 2015/0155784 A1
(43) Pub. Date: Jun. 4, 2015

(54) SWITCH MODE POWER SUPPLY WITH TRANSIENT CONTROL AND CONTROL METHOD THEREOF

(71) Applicant: Chengdu Monolithic Power Systems Co., Ltd., Chengdu (CN)

(72) Inventors: Qian Ouyang, Hanzhou (CN); Wei Yuan, Hangzhou (CN)

(21) Appl. No.: 14/552,104

(22) Filed: Nov. 24, 2014

(30) Foreign Application Priority Data
Dec. 3, 2013 (CN) 201310642504.9

(51) Int. Cl. H02M 3/156

(52) U.S. Cl. CPC H02M 3/1563; H02M 2001/0019

(57) ABSTRACT

A SMPS has a switching circuit, an adding circuit and a comparing circuit. The adding circuit adds the output voltage feedback signal of the SMPS to the output current feedback signal of the SMPS to provide a combined feedback signal. The comparing circuit compares the combined feedback signal with a reference signal and provides a comparing signal. And the power switch of the SMPS is controlled based on the comparing signal.

### CROSS-REFERENCE TO RELATED APPLICATION(S)

This application claims the benefit of CN application No. 201310642504.9, filed on Dec. 3, 2013, and incorporated herein by reference.

### TECHNICAL FIELD

The present invention generally relates to electrical circuit, and more particularly but not exclusively relates to transient response control circuit and control method in switch mode power supply.

### BACKGROUND

Direct-Current to Direct-Current (DC-DC) Switch Mode Power Supply (SMPS) is used for converting a DC input voltage into a DC output voltage with predetermined value via controlling ON and OFF actions of a switch. Fixed frequency control is a conventional switching control method used in a SMPS and adopts a clock signal which has a fixed frequency. The clock signal is used to trigger a switching signal which controls the switch into a falling edge or a leading edge at each cycle, thus the switching signal has a fixed frequency. Fixed frequency control has advantage of low Electronic Magnetic Interference (EMI) effect, and thus is widely used, for example, in power supply for data communication system which is sensitive to the EMI noise.

When load changes, the response usually has some delay, and the output voltage would contain fluctuant ripples before it stabilizes at a predetermined level. However, some applications require that the output voltage stabilizes quickly.

Accordingly a control circuit having fast response speed is required to address one or some of the above deficiencies.

### SUMMARY

In one embodiment, a SMPS comprises: a switching circuit having a power input terminal configured to receive an input voltage and a power output terminal configured to provide an output voltage for supplying a load, the switching circuit having a switch; an adding circuit having a first input, a second input and an output, the first input of the adding circuit coupled to the power output terminal configured to receive an output voltage feedback signal indicative of the output voltage, the second input of the adding circuit configured to receive an output current feedback signal indicative of an output current of the switching circuit, and the adding circuit configured to add the output voltage feedback signal into the output current feedback signal and provide a combined feedback signal at the output of the adding circuit; a comparing circuit having a first input, a second input and an output, the first input of the comparing circuit coupled to the output of the adding circuit configured to receive the combined feedback signal, the second input of the comparing circuit configured to receive a reference signal, and the comparing circuit configured to compare the combined feedback signal with the reference signal and provide a comparing signal at the output of the comparing circuit; a logic circuit having an input and an output, the input of the logic circuit coupled to the output of the comparing circuit configured to receive the comparing signal; and a driving circuit having an input and an output, the input of the driving circuit coupled to the output of the logic circuit, and the output of the driving circuit coupled to the switch of the switching circuit configured to control ON and OFF of the switch.

In another embodiment, a control circuit for controlling a switch in a switching circuit, the switching circuit having a power input terminal configured to receive an input voltage and a power output terminal configured to provide an output voltage for supplying a load, the control circuit comprising: an adding circuit having a first input, a second input and an output, the first input of the adding circuit coupled to the power output terminal configured to receive an output voltage feedback signal indicative of the output voltage, the second input of the adding circuit configured to receive an output current feedback signal indicative of an output current of the switching circuit, and the adding circuit configured to add the output voltage feedback signal into the output current feedback signal and provide a combined feedback signal at the output of the adding circuit; a comparing circuit having a first input, a second input and an output, the first input of the comparing circuit coupled to the output of the adding circuit configured to receive the combined feedback signal, the second input of the comparing circuit configured to receive a reference signal, and the comparing circuit configured to compare the combined feedback signal with the reference signal and provide a comparing signal at the output of the comparing circuit; and a logic circuit having an input and an output, the input of the logic circuit coupled to the output of the comparing circuit configured to receive the comparing signal, the output of the logic circuit is coupled to the switching circuit configured to turn ON and OFF of the switch.

In yet another embodiment, a transient response control method of controlling a switch in a SMPS comprising: detecting an output voltage of the SMPS to obtain an output voltage feedback signal; detecting an output current of the SMPS to obtain an output current feedback signal; adding the output voltage feedback signal into the output current feedback signal to obtain a combined feedback signal; comparing the combined feedback signal to a reference signal to obtain a comparing signal; and turning ON and OFF the switch according to the comparing signal.

### BRIEF DESCRIPTION OF THE DRAWINGS

Non-limiting and non-exhaustive embodiments are described with reference to the following drawings. The drawings are only for illustration purpose. Usually, the drawings only show part of the system or circuit of the embodiments.

FIG. 1 illustrates a block diagram of a SMPS according to an embodiment of the present invention.

FIG. 2 illustrates a block diagram of a SMPS 200 according to another embodiment of the present invention.

FIG. 3 illustrates a block diagram of a SMPS 300 according to yet another embodiment of the present invention.

FIG. 4 illustrates a block diagram of a SMPS 400 according to a fourth embodiment of the present invention.

FIG. 5 illustrates a circuit diagram of a SMPS 500 according to an embodiment of the present invention.

FIG. 6 illustrates a waveform diagram of a plurality of signals in a SMPS according to an embodiment of the present invention.

FIG. 7 illustrates a waveform diagram of different transient response performances during step-up of load according to an embodiment of the present invention and a conventional control method.

FIG. 8 illustrates a waveform diagram of different transient response performances during step-down of load according to an embodiment of the present invention and a conventional control method.

FIG. 9 illustrates a block diagram of transient response control method 900 according to an embodiment of the present invention.

The use of the same reference label in different drawings indicates the same or like components.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

The phrase “couple” in the description may refer to direct connection or indirect connection via interim media. The interim media may include conductor which may has resistance, parasitic capacitance and/or parasitic inductance. The interim media may include diode or other component/ circuit. The phrase “circuit” in the description may have forms of Integrated Circuit (IC), device, printed circuit board system or others.

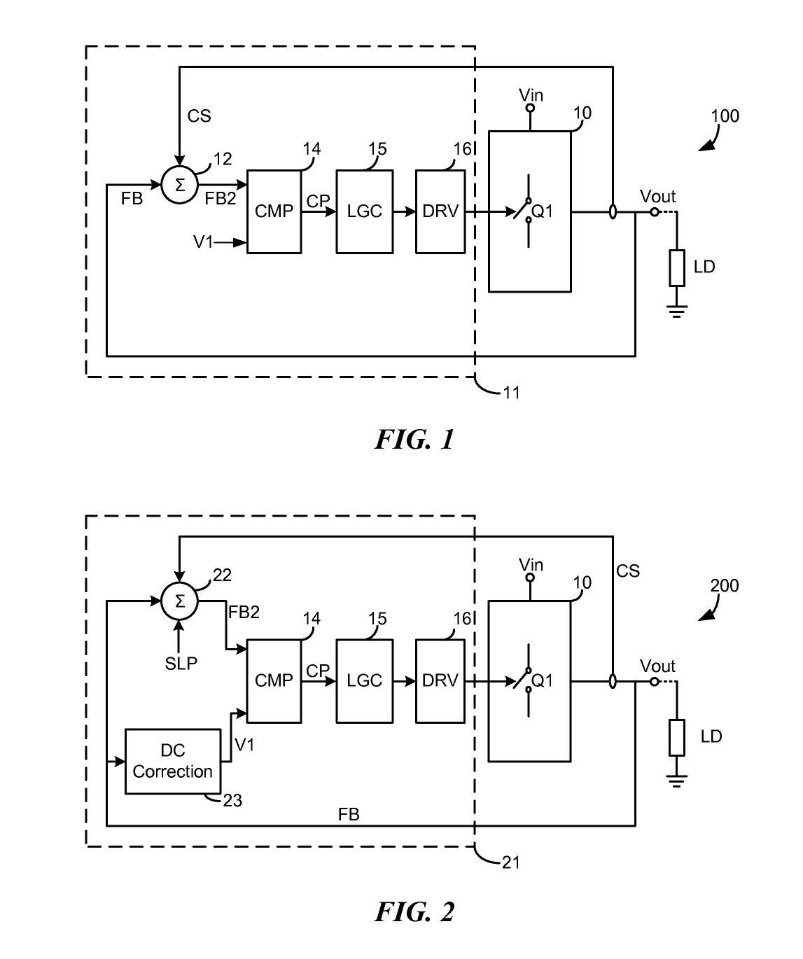

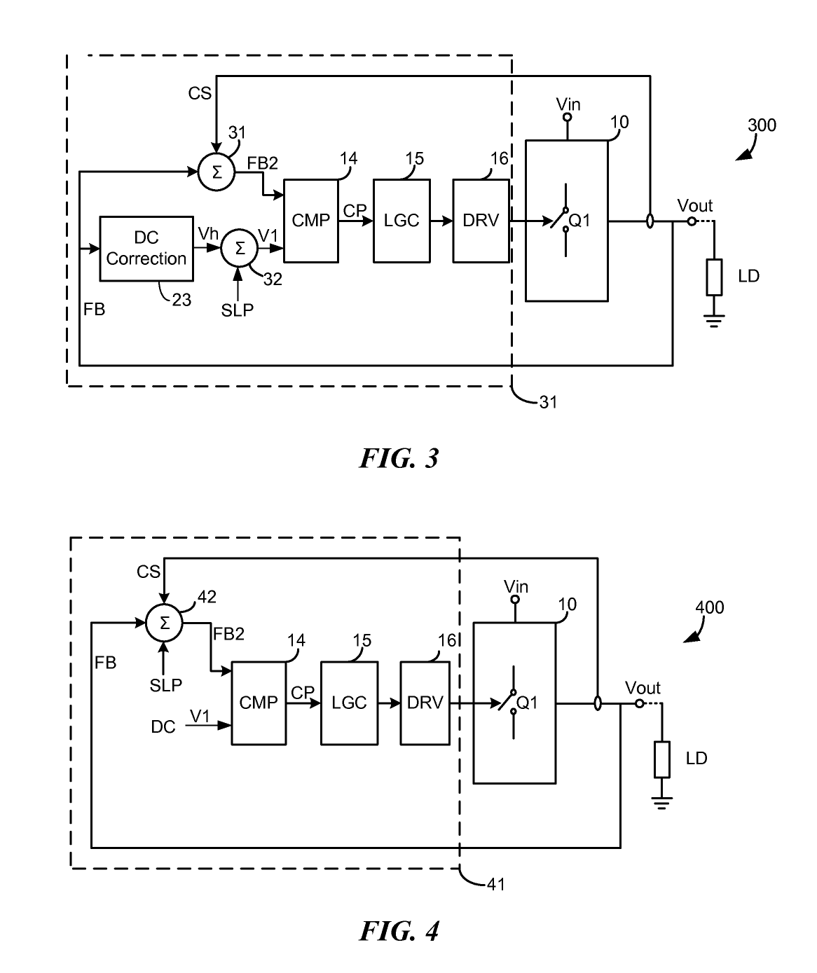

FIG. 1 illustrates a SMPS 100 according to an embodiment of the present invention. SMPS 100 comprises a switching circuit 10, an adding circuit 12, a comparing circuit 14 (CMP), a logic circuit 15 (LGC) and a driving circuit 16 (DRV). Switching circuit 10 has a power input terminal and a power output terminal, wherein the power input terminal receives an input voltage Vin, and the power output terminal outputs an output voltage Vout for supplying a load LD. The labels of Vin and Vout may also refer to the power input terminal and power output terminal respectively in the description. Switching circuit 10 comprises a switch Q1, and switching circuit 10 converts the input voltage Vin into the output voltage Vout via the ON and OFF of switch Q1. In one embodiment, switching circuit 10 comprises a DC-DC step down converter (buck), where the output voltage Vout is lower than the input voltage Vin. Adding circuit 12 has a first input, a second input and an output, wherein the first input is coupled to the power output terminal Vout configured to receive an output voltage feedback signal FB which indicates output voltage Vout. In one embodiment, output voltage feedback signal FB equals output voltage Vout itself. In another embodiment, output voltage feedback signal FB is obtained from detecting output voltage Vout via a feedback circuit. The second input of adding circuit 12 receives an output current feedback signal CS indicating the current flowing through switch Q1 or current on other terminals. In one embodiment, output current feedback signal CS is a voltage signal obtained from sensing the current flowing through switch Q1 by a current detecting circuit. Adding circuit 12 at least adds output voltage feedback signal FB and output current feedback signal CS and provides a combined feedback signal FB2. Comparing circuit 14 has a first input, a second input and an output, wherein the first input of comparing circuit 14 is coupled to the output of adding circuit 12 configured to receive combined feedback signal FB2, the second input of comparing circuit 14 receives a reference signal V1. Comparing circuit 14 compares combined feedback signal FB2 to reference signal V1 and outputs a comparing signal CP. SMPS 100 controls switching circuit 10 based on comparing signal CP. In one embodiment, reference signal V1 is obtained by calculating the integral of the output voltage feedback signal FB and then filtering the calculated integral. As shown in FIG. 2, reference signal V1 is an output voltage correction signal generated by a DC correction circuit 23, where DC correction circuit 23 has low frequency filtering characteristic in order that output voltage correction signal V1 changes slowly. In another embodiment, reference signal V1 is a DC signal, as seen in FIG. 4. SMPS 100 further may adopt slope compensation, and a slope signal SLP is added to an input of adding circuit 12. For example, in the embodiment shown in FIG. 2, slope signal SLP is added to output voltage feedback signal FB and output current feedback signal CS to get a combined feedback signal FB2. And in another embodiment as shown in FIG. 3, slope signal SLP is added to an output voltage correction signal provided by DC correction circuit 23 in order to get reference signal V1. Slope signal SLP has a slope during at least one period of a cycle, for example slope signal SLP has a slope during a period when the output current is increasing. In one embodiment, slope signal SLP is a saw-tooth waveform signal.

Continuing with FIG. 1, logic circuit 15 has an input and an output, wherein the input of logic circuit 15 is coupled to the output of comparing circuit 14 to receive comparing signal CP, and the output of logic circuit 15 is coupled to the input of driving circuit 16. Logic circuit 15 outputs a Pulse Width Modulation (PWM) signal according to comparing signal CP. Driving circuit 16 converts the PWM signal into a voltage signal with a value suitable for driving switch Q1 of switching circuit 10. The output of driving circuit 16 is coupled to a control end of switch Q1 for controlling the ON and OFF of switch Q1. In one embodiment, SMPS 100 comprises switching circuit 10 and control circuit 11. Where control circuit 11 comprises adding circuit 12, comparing circuit 14, logic circuit 15 and driving circuit 16. In one embodiment, control circuit 11 is integrated on an Integrated Circuit (IC). And in another embodiment, adding circuit 12, comparing circuit 14 and logic circuit 15 are integrated on an IC.

FIG. 2 illustrates a block diagram of a SMPS 200 according to an embodiment of the present invention. Compared to SMPS 100 in FIG. 1, SMPS 200 further comprises a DC correction circuit 23, and an adding circuit 22 adds output voltage feedback signal FB, output current feedback signal CS and slope signal SLP together to get a combined feedback signal FB2. In order to simplify the description, the same or similar components or connections of SMPS 200 with those of SMPS 100 will not be described in detail. DC correction circuit 23 has an input and an output, wherein the input of DC correction circuit 23 is coupled to power output terminal Vout to receive output voltage feedback signal FB, and the output of DC correction circuit 23 provides reference signal V1. In one embodiment, reference signal V1 is an output voltage correction signal which is obtained by at least calculating the integral of output voltage Vout based on a period of time. In one embodiment, reference signal V1 is from firstly integrating output voltage Vout over time and then being filtered with low frequency bandwidth. In another embodiment, reference signal V1 is a DC signal. Besides having a first input receiving an output voltage feedback signal FB and a second input receiving an output current feedback signal CS, adding circuit 22 further has a third input receiving a slope signal SLP, and the combined feedback signal FB2 outputted by adding circuit 22 is a combined signal by adding output voltage feedback signal FB, output current feedback signal CS and slope signal SLP together, or FB2=FB+CS+SLP. Comparing circuit 14 then compares combined feedback signal FB2 to an output voltage correction signal V1 to get a comparing signal CP. And control circuit 21 controls the ON and OFF of switch Q1 in switching circuit 10 based on comparing signal CP.

FIG. 3 illustrates a block diagram of a SMPS 300 according to an embodiment of the present invention. Compared to SMPS 100 in FIG. 1, SMPS 300 further comprises a DC correction circuit 23 and a second adding circuit 32. In SMPS 300, a slope signal SLP is added together with an output voltage correction signal Vh to get the reference signal V1, whereas in SMPS 200 in FIG. 2, slope signal SLP is added together with output voltage feedback signal FB and output current feedback signal CS to get a combined feedback signal FB2. In order to simplify the description, the components or connections in SMPS 300 which are similar or the same with those in SMPS 100 are not to be described in detail. DC correction circuit 23 provides output voltage correction signal Vh which may be obtained by calculating the integral of the output voltage Vout and then filtering the integral. The second adding circuit 32 has a first input, a second input and an output, wherein the first input of second adding circuit 32 is coupled to DC correction circuit 23 to receive output voltage correction signal Vh, the second input of second adding circuit 32 receives slope signal SLP, and the output of the second adding circuit 32 provides reference signal V1 which is delivered to comparing circuit 14. Accordingly, the first input of comparing circuit 14 receives combined feedback signal FB2 which is a combined signal of output voltage feedback signal FB and output current feedback signal CS, or FB2=FB+CS; and the second input of comparing circuit 14 receives reference signal V1 which is a combined signal of output voltage correction signal Vh and slope signal SLP; and comparing circuit 14 compares combined feedback signal FB2 with reference signal V1, and provides comparing signal CP. Control circuit 31 controls the ON and OFF of switch Q1 of switching circuit 10 according to the comparing signal CP.

FIG. 4 illustrates a block diagram of SMPS 400 according to an embodiment of the present invention. Compared to SMPS 100 in FIG. 1, SMPS 400 further adds a slope signal SLP into output voltage feedback signal FB and output current feedback signal CS to get a combined feedback signal, wherein reference signal V1 in SMPS 400 is a DC signal. In order to simplify the description, the components or connections in SMPS 400 which are similar or the same with those in SMPS 100 are not to be described in detail. DC reference signal V1 may be generated by a DC reference voltage generator. Accordingly, combined feedback signal FB2 (FB2=FB+CS+SLP) is compared to DC reference signal V1 to get a comparing signal CP. And control circuit 41 controls the ON and OFF of switch Q1 in switching circuit 10 based on comparing signal CP.

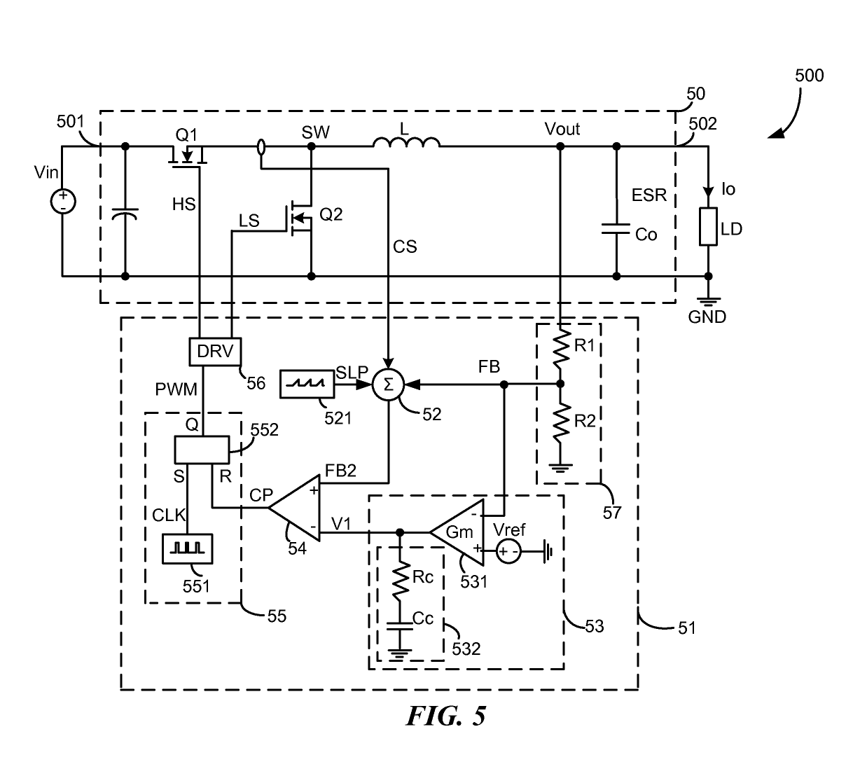

FIG. 5 illustrates a circuit diagram of a SMPS 500 according to an embodiment of the present invention. SMPS 500 comprises a switching circuit 500 and a control circuit 51. Control circuit 51 comprises an adding circuit 52, a slope signal generator 521, a DC correction circuit 53, a comparing circuit 54, a logic circuit 55, a driving circuit 56 and an output voltage feedback circuit 57. In one embodiment, control circuit 51 is integrated in an electronic package. And in another embodiment, control circuit 51 is integrated on a semiconductor die. And yet in another embodiment, part of control circuit 51 is integrated on a semiconductor die.

Switching circuit 50 is a buck-type switching circuit. Switching circuit 50 comprises a switch Q1, a rectifier Q2, an output inductor L and an output capacitor Co. Switch Q1 has a first end, a second end and a control end, wherein the first end of switch Q1 is coupled to a power input terminal configured to receive input voltage Vin, the second end of switch Q1 is coupled to a switching node SW, and the control end of switch Q1 is coupled to driving circuit 56. Rectifier Q2 has a first end, a second end and a control end, wherein the first end of rectifier Q2 is coupled to switching node SW, the second end of rectifier Q2 is coupled to reference ground GND and the control end of rectifier Q2 is coupled to driving circuit 56. In another embodiment, rectifier Q2 may be replaced by a non-synchronous rectifier such as a diode. Switch Q1 and rectifier Q2 each comprises a Metal Oxide Semiconductor Field Effect Transistor (MOSFET). A MOSFET may comprise an enhanced N-channel MOSFET. In another embodiment, the switch and the rectifier each may comprise a P-channel MOSFET. In yet other embodiments, the switch and the rectifier each may comprise other type of device, such as Junction Field Effect Transistor (JFET) or Bipolar Junction Transistor (BJT). Output inductor L has a first end and a second end, wherein the first end of inductor L is coupled to switching node SW, and the second end of inductor L is coupled to output capacitor Co. Output capacitor has a first end and a second end, wherein the first end of Output capacitor Co is coupled to output inductor L and the second end of output capacitor Co is coupled to reference ground GND. The first end of output capacitor Co is coupled to the power output terminal and provides output voltage Vout. Switching circuit 50 may further comprise an input capacitor Cin configured to filter an input voltage Vin. Besides power input terminal Vin and power output terminal Vout, switching circuit 50 further has a first control signal terminal configured to receive a first control signal HS and a second control signal terminal configured to receive a second control signal LS, wherein the first control signal terminal is coupled to the control end of switch Q1, and the second control signal terminal is coupled to the control end of rectifier Q2. When switch Q1 is ON, rectifier Q2 is OFF, the voltage at switching node SW increases to approximate the level of input voltage Vin, current flows though output inductor L from switching node SW to power output terminal Vout, and load current lo increases. At the meantime, output capacitor Co may be charged, and output voltage Vout may increase. Then, switch Q1 is in OFF state, rectifier Q2 is in ON state, current flows through output inductor L and rectifier Q2 from the power output terminal to reference ground GND. At the meantime, output capacitor Co may be discharged and output voltage Vout may decrease. The voltage at switching node SW is regulated by the PWM signal outputted by logic circuit 55, and the signal waveform shape of the voltage at switching node SW is similar to the shape of the PWM signal. The voltage at switching node SW is filtered by output inductor L and output capacitor Co into a substantial DC output voltage Vout. This DC output voltage Vout may be affected by the change of load LD. For example, when load LD increases, the resistance of load LD decreases, and output voltage Vout decreases. And when load LD decreases, the resistance of load LD increases and output voltage Vout increases. And further due to the existence of Equivalent Series Resistance (ESR) of output capacitor Co, output voltage Vout has ripple with the same frequency of the PWM signal. In some other embodiments, switching circuit may comprise a step up (boost) converter or other type of converter.

Adding circuit 52 adds an output current feedback signal CS indicative of the output current flowing through switch Q1, an output voltage feedback signal FB indicative of the output voltage Vout, and a slope signal SLP together to get a combined feedback signal FB2. In one embodiment, adding circuit 52 adds up output current feedback signal CS, output voltage feedback signal FB and slope signal SLP with a proportion of 1:1:1. In other embodiments, adding circuit 52 may add up output current feedback signal CS, output voltage feedback signal FB and slope signal SLP with any other proportion. Output current feedback signal CS may be obtained by detecting the current flowing through switch Q1, and the increasing stage of current flowing through switch Q1 can represent the change of output current. In another embodiment, output current feedback signal CS may be obtained by detecting the current flowing through output inductor L. Output current feedback signal may be obtained by any type of suitable current detecting circuit or current detecting method.

Slope signal SLP is generated and outputted by slope signal generator 521. In one embodiment, slope signal SLP has the same frequency with a clock signal CLK, and has a slope at least at the period when output current is increasing.

DC correction circuit 53 comprises a trans-conductance amplifier 531 and a compensation circuit 532. Trans-conductance amplifier 531 has a first input, a second input and an output. Where the first input of amplifier 531 is coupled to the power output terminal configured to receive output voltage feedback signal FB, and the second input of amplifier 531 is coupled to a reference voltage Vref. In the shown embodiment, trans-conductance amplifier 531 has a non-inverting input coupled to reference voltage Vref and has an inverting input coupled to output voltage feedback signal FB. Trans-conductance amplifier 531 integrates and amplifies the difference between output voltage feedback signal FB and reference voltage Vref and outputs a current signal. This current signal is converted by compensation circuit 532 into an output voltage correction signal V1 provided at the output of trans-conductance amplifier 531. Compensation circuit 532 comprises a capacitor Cc and resistor Rc coupled in series, and one end of the compensation circuit 52 or said the serially coupled capacitor Cc and resistor Rc is coupled to reference ground GND, and the other end of the serially coupled capacitor Cc and resistor Rc is coupled to the output of trans-conductance amplifier 531. Wherein capacitor Cc is coupled to reference ground GND and resistor Rc is coupled to the output of trans-conductance amplifier 531. Compensation circuit 532 is set to have low frequency pass filtering characteristic and the outputted output voltage correction signal V1 has low frequency, or in other words, the shape of output voltage correction signal V1 is flat. When load increases, output voltage feedback signal FB decreases, and output voltage correction signal V1 increases slowly. And in another embodiment, when output voltage Vout decreases, the output voltage feedback signal may increase in contrary, accordingly the output voltage feedback signal is supplied to non-inverting input of trans-conductance amplifier and output voltage correction signal also increases slowly.

Comparing circuit 54 has a non-inverting input, an inverting input and an output, wherein the non-inverting input of comparing circuit 54 receives combined feedback signal FB2, the inverting input of comparing circuit 54 receives reference signal V1 (or output voltage correction signal V1 in this embodiment), and the output of comparing circuit 54 provides comparing signal CP coupled to logic circuit 55 for controlling the ON and OFF of switch Q1. When combined feedback signal FB2 is higher than output voltage correction signal V1, comparing signal CP is set to logic HIGH, and logic circuit 55 outputs the PWM signal in logic LOW to turn OFF switch Q1. And in another embodiment, the signal received by the non-inverting input and the signal received by the inverting input of comparing circuit 54 may be exchanged as would be known to person of ordinary skill in the art.

Logic circuit 55 comprises a clock signal generator 551 and a flip latch 552. Clock signal generator 551 generates the clock signal CLK. Clock signal CLK presents a HIGH logic pulse at the beginning of each cycle, and turns ON switch Q1 at each cycle. Flip latch 552 has a set input S, a reset input R and an output Q, wherein the set input S is coupled to clock signal generator 551 to receive clock signal CLK, the reset input R is coupled to the output of comparing circuit 54 to receive comparing signal CP, and output Q provides PWM signal for controlling the ON and OFF of switch Q1. When clock signal CLK is in logic HIGH, PWM signal at output Q of flip latch 552 is set in logic HIGH. The PWM signal would keep in logic HIGH until when comparing signal CP turns in logic HIGH and then PWM signal is reset in logic LOW. When the next HIGH logic pulse of the clock signal CLKI comes, PWM signal is set HIGH again. In another embodiment, the set input S of flip latch 552 receives the comparing signal and the reset input R of flip latch 552 receives the clock signal, and switch Q1 turns ON when the PWM signal outputted by flip latch 552 is in logic LOW.

Driving circuit 56 converts the logic signal PWM outputted by logic circuit 55 into the first control signal HS at a voltage level suitable for driving switch Q1, and into the second control signal LS at a voltage level suitable for driving rectifier Q2. In another embodiment, switching circuit 50 comprises a non-synchronous rectifier and the driving circuit outputs one control signal HS to switching circuit 50.

Control circuit 51 may further comprise an output voltage feedback circuit 57. Output voltage feedback circuit 57 is coupled to the power output terminal of switching circuit 50 and converts output voltage Vout into an output voltage feedback signal FB. Output voltage feedback circuit 57 comprises a resistor divider comprising a first resistor R1 and a second resistor R2, wherein a first end of the first resistor R1 is coupled to power output terminal Vout of switching circuit 50, a second end of the first resistor R1 is coupled to the second resistor R2, the other end of the second resistor R2 is coupled to reference ground GND. And the common end of the first resistor R1 and the second resistor R2 forms the output of output voltage feedback circuit 57 to provide output voltage feedback signal FB. Accordingly, output voltage feedback signal FB is proportional to output voltage Vout as FB=R2/(R1+R2)*Vout. In other embodiments, output voltage feedback circuit 57 may be any other suitable circuit, or comprise other type of sensing element.

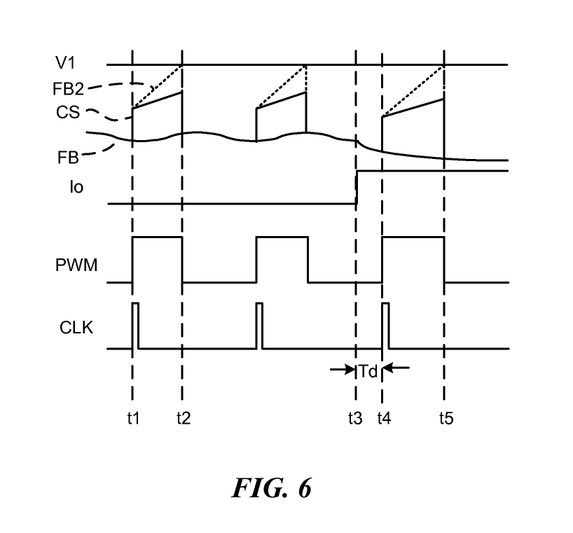

FIG. 6 illustrates a waveform diagram of a plurality of signals in a SMPS according to an embodiment of the present invention. The signals from the above to the bottom are respectively reference signal V1, combined feedback signal FB2, output current feedback signal CS, output voltage feedback signal FB, load current lo, PWM signal and clock signal CLK. The working function of the SMPS will be described with reference to the configuration in FIG. 5 and the waveforms in FIG. 6. Since compensation circuit 532 in FIG. 5 adopts low frequency pass filtering, output voltage correction signal V1 is smooth, and is substantially a DC voltage in short time. Accordingly complex compensation correction towards compensation circuit 532 is not needed and the circuit is simplified. In another embodiment, reference signal V1 may be direct a DC signal. Output voltage feedback signal FB has periodical ripple, and is also affected by the change of load. At time t3, the load or load current lo increases, output voltage feedback signal FB decreases along with the decrease of output voltage Vout. Output current feedback signal CS is a sensing signal of the current flowing through switch Q1. Output current feedback signal CS increases when switch Q1 is in ON state (PWM signal in logic HIGH) and is in zero current when switch Q1 is in OFF state. Combined feedback signal FB2 is a combined signal by adding output current feedback signal CS, output voltage feedback signal FB and slope signal SLP together, which is represented as FB2=CS+FB+SLP. Slope signal SLP is adopted for slope compensation, which triggers ON of switch Q1 more swiftly and more reliably. As shown in FIG. 6, when output voltage feedback signal FB increases, the initial value of combined feedback signal FB2 increases; and when output voltage feedback signal FB decreases, the initial value of combined feedback signal FB2 decreases too.

At time t1, clock signal CLK has a HIGH logic pulse, flip latch 552 is set HIGH, and output Q provides the PWM signal in logic HIGH. Accordingly, switch Q1 turns ON, and output current feedback signal CS increases. And combined feedback signal FB2 also increases. At time t2, when combined feedback signal FB2 increases to be higher than reference signal V1, comparing signal CP outputted by comparing circuit 24 is in logic HIGH to reset flip latch 552, the PWM signal outputted by flip latch 552 is in logic LOW, and switch Q1 turns OFF. When the logic HIGH pulse comes at the next cycle, PWM signal is set HIGH again to turn ON switch Q1.

At time t3, load current lo increases, output voltage feedback signal FB decreases. At that time, PWM signal is in logic LOW and switch Q1 is in OFF state. At time t4, clock signal CLK has a high pulse, and PWM signal turns to logic HIGH to turn ON switch Q1. Since output voltage feedback signal FB at time t4 is lower than that at time t1, combined feedback signal FB2 has a lower initial value at time t4 than that at time t1, longer time is needed from combined feedback signal FB2 increases to be higher than reference signal V1 after time t4. This directly leads to higher duty cycle of the PWM signal and is desirable for load increase. From FIG. 6 it can be seen that the response time of responding to load change is time period Td which is less that a cycle period. This fast response towards load transient lowers down the importance of adjusting output voltage correction signal V1 during load transient, thus no complex adjustment is needed to the compensation circuit. And accordingly, the control circuit and control method are simple, and the control is stable.

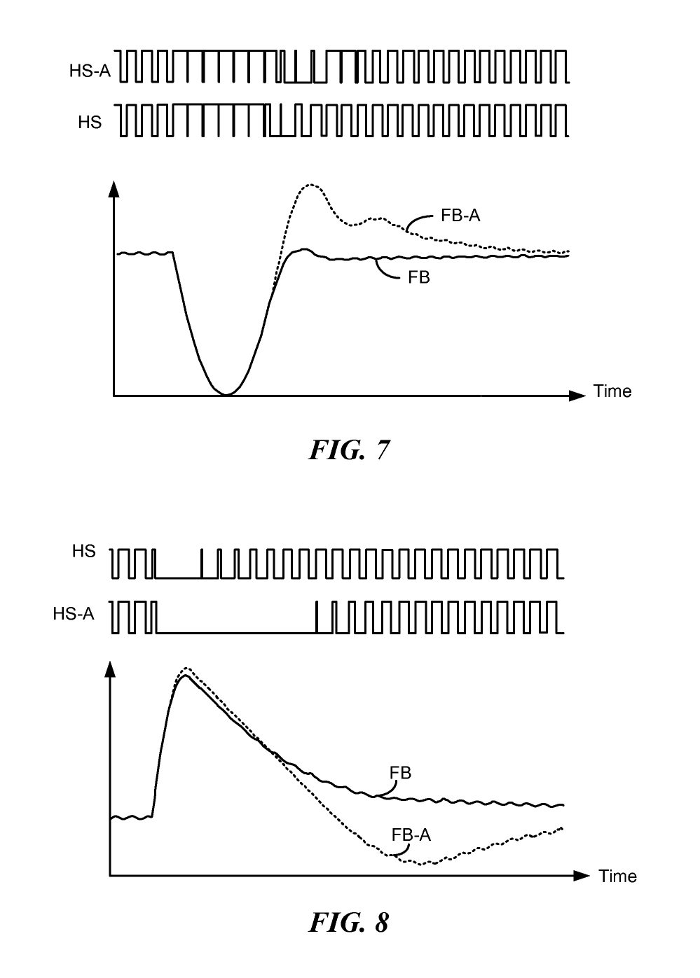

FIG. 7 illustrates a waveform diagram of signals for transient response during load step-up according to an embodiment of the present invention, and according to a conventional method respectively. Where signal HS denotes a PWM control signal according to the embodiment of the present invention, signal FB denotes an output voltage feedback signal according to the embodiment of the present invention, signal HS-A denotes a PWM control signal according to the conventional method which adopts conventional compensation network adjustment, and signal FB-A denotes output voltage feedback signal according to the conventional method. The other conditions such as the input voltage, the predetermined output voltage, the load, etc. are the same in the two cases. From the figure, it can be seen that when load step-up happens, output voltage feedback signal (FB or FB-A) decreases, and then output voltage feedback signal (FB or FB-A) bounces back to the predetermined value. After that, output voltage feedback signal FB according to the embodiment of the present invention comes stable at this predetermined value quickly, and has small overshoot and small ripples, while output voltage feedback signal FB-A in the conventional method has high overshoot and large ripples. Thus, during load step-up, the SMPS and associated control method according to the embodiment of the present invention have faster transient response and more stable control than the SMPS according to the conventional one.

FIG. 8 illustrates a waveform diagram of signals for transient response during load step-down according to an embodiment of the present invention and according to a conventional method respectively. Where signal HS denotes a PWM control signal according to the embodiment of the present invention, signal FB denotes an output voltage feedback signal according to the embodiment of the present invention, signal HS-A denotes a PWM control signal according to the conventional method which adopts conventional compensation network adjustment, and signal FB-A denotes output voltage feedback signal according to the conventional method. The other conditions such as the input voltage, the predetermined output voltage, the load, etc. are the same in the two cases. From the figure, it can be seen that when load step-down happens, output voltage feedback signal (FB or FB-A) increases, and then output voltage feedback signal (FB or FB-A) bounces back to the predetermined value. Output voltage feedback signal FB according to the embodiment of the present invention comes stable at this predetermined value quickly and has small ripples, while output voltage feedback signal FB-A according to the conventional approach has deep undershoot and larger ripples. Thus, during load step-down, the SMPS and associated control method according to the embodiment of the present invention have faster transient response and more stable control than the SMPS according to the conventional approach.

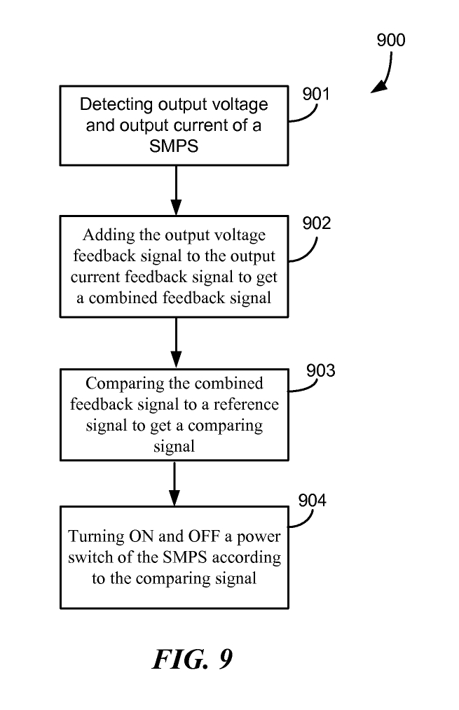

FIG. 9 illustrates a diagram of transient response control method 900 of controlling a SMPS according to an embodiment of the present invention. Transient response control method 900 comprises at step 901 detecting an output voltage of the SMPS to obtain an output voltage feedback signal, and detecting an output current of the SMPS to obtain an output current feedback signal. In one embodiment, the output voltage feedback signal is proportional to the output voltage of the SMPS. And in one embodiment, the output current feedback signal is proportional to the current flowing through a switch of the SMPS. Method 900 further comprises at step 902 adding the output voltage feedback signal and the output current feedback signal together to obtain a combined feedback signal. In one embodiment, the combined feedback signal is obtained by adding the output voltage feedback signal and the output current feedback signal together with a proportion of 1:1. In another embodiment, the combined feedback signal is obtained by adding the output voltage feedback signal, the output current feedback signal and a slope signal together. Method 900 further comprises at step 903 comparing the combined feedback signal with a reference signal to get a comparing signal. In one embodiment, the reference signal is obtained by calculating the integral of the output voltage over the time and then filtering the integral, and the reference signal indicates the change of output voltage in a long time period, in order to correct the DC signal offset of the output voltage. Method 900 further comprises in step 904 turning ON and OFF the switch of the SMPS according to the comparing signal. In one embodiment, when the combined feedback signal is higher than the reference signal, the switch of the SMPS is turned OFF, and when a pulse of a clock signal comes, the switch of the SMPS is turned ON.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

I/we claim:

1. A Switch Mode Power Supply, comprising:
a switching circuit having a power input terminal configured to receive an input voltage, a power output terminal configured to provide an output voltage for supplying a load, and a switch;
an adding circuit having a first input, a second input and an output, the first input of the adding circuit coupled to the power output terminal configured to receive an output voltage feedback signal indicative of the output voltage, the second input of the adding circuit configured to receive an output current feedback signal indicative of an output current of the switching circuit, and the adding circuit configured to add the output voltage feedback signal into the output current feedback signal and provide a combined feedback signal at the output of the adding circuit;
a comparing circuit having a first input, a second input and an output, the first input of the comparing circuit coupled to the output of the adding circuit configured to receive the combined feedback signal, the second input of the comparing circuit configured to receive a reference signal, and the comparing circuit configured to compare the combined feedback signal with the reference signal and provide a comparing signal at the output of the comparing circuit;
a logic circuit having an input and an output, the input of the logic circuit coupled to the output of the comparing circuit configured to receive the comparing signal; and
a driving circuit having an input and an output, the input of the driving circuit coupled to the output of the logic circuit, and the output of the driving circuit coupled to the switch of the switching circuit configured to control ON and OFF of the switch.

2. The Switch Mode Power Supply of claim 1, further comprising a Direct-Current (DC) correction circuit, wherein:
the DC correction circuit has an input and an output, wherein the input of the DC correction circuit is coupled to the power output terminal configured to receive the output voltage feedback signal, and the output of the DC correction circuit is configured to provide the reference signal, wherein the reference signal is obtained by calculating the integral of the output voltage feedback signal based on a period of time; and
the adding circuit further has a third input configured to receive a slope signal, wherein the adding circuit is configured to add the output voltage feedback signal, the output current feedback signal and the slope signal together to provide the combined feedback signal.

3. The Switch Mode Power Supply of claim 2, wherein the DC correction circuit comprises:
a trans-conductance amplifier having a first input, a second input and an output, wherein the first input of the trans-conductance amplifier is configured to receive the output voltage feedback signal and the second input of the trans-conductance amplifier is configured to receive a reference voltage; and
a compensation circuit comprising a capacitor and a resistor coupled in series, wherein a first end of the serially coupled capacitor and resistor is coupled to a reference ground, and the other end of the serially coupled capacitor and resistor is coupled to the output of the trans-conductance amplifier, and wherein the output of the trans-conductance amplifier is configured to provide the reference signal.

4. The Switch Mode Power Supply of claim 3, wherein the compensation circuit has a low frequency filtering function.

5. The Switch Mode Power Supply of claim 1, wherein the reference signal is a DC signal.

6. The Switch Mode Power Supply of claim 1, further comprising:
a DC correction circuit having an input and an output, wherein the input of the DC correction circuit is coupled to the power output terminal configured to receive the output voltage feedback signal, and the output of the DC correction circuit is configured to provide an output voltage correction signal, and wherein the output voltage correction signal is obtained by calculating the integral of the output feedback signal based on a period of time and then filtering the integral; and
a second adding circuit having a first input, a second input and an output, wherein the first input of the second adding circuit is coupled to the DC correction circuit configured to receive the output voltage correction signal, the second input of the second adding circuit is configured to receive a slope signal, and the output of the second adding circuit is configured to provide the reference signal.

7. The Switch Mode Power Supply of claim 1, wherein the logic circuit comprises:
a clock signal generator configured to generate a clock signal; and
a flip latch having a first input, a second input and an output, wherein the first input of the flip latch is coupled to the clock signal generator configured to receive the clock signal, the second input of the flip latch is coupled to the output of the comparing circuit configured to receive the comparing signal, and the output of the flip latch is coupled to the input of the driving circuit.

8. The Switch Mode Power Supply of claim 7, further comprising a slope signal generator, the slope signal generator configured to generate a slope signal, and wherein the slope signal is configured to have a same frequency with the clock signal.

9. The Switch Mode Power Supply of claim 1, further comprising an output voltage feedback circuit, the output voltage feedback circuit comprises:
a first resistor having a first end and a second end, wherein the first end of the first resistor is coupled to the power output terminal; and
a second resistor having a first input and a second input, wherein the first end of the second resistor is coupled to the second input of the first resistor, the second end of the second resistor is coupled to a reference ground and the second end of the first resistor is configured to provide the output voltage feedback signal.

10. The Switch Mode Power Supply of claim 1, wherein the output current feedback signal is obtained by detecting the current flowing through the switch.

11. The Switch Mode Power Supply of claim 1, wherein the switch having a first end, a second end and a control end, wherein the first end of the switch is coupled to the power input terminal, the second end of the switch is coupled to a switching node, and the control end of the switch is coupled to the output of the driving circuit, and wherein the switching circuit further comprises:
a rectifier having a first end and a second end, wherein the first end of the rectifier is coupled to the switching node and the second end of the rectifier is coupled to a reference ground;
an output inductor having a first end and a second end, wherein the first end of the output inductor is coupled to the switching node; and
an output capacitor having a first end and a second end, wherein the first end of the output capacitor is coupled to the second end of the output inductor, the second end of the output capacitor is coupled to the reference ground and the first end of the output capacitor is configured to provide the output voltage.

12. The Switch Mode Power Supply of claim 11, wherein the rectifier comprises a synchronous rectifier, the synchronous rectifier further has a control end, and wherein the control end of the synchronous rectifier is coupled to the driving circuit.

13. A control circuit for controlling a switch in a switching circuit, the switching circuit having a power input terminal configured to receive an input voltage and a power output terminal configured to provide an output voltage for supplying a load, the control circuit comprising:
an adding circuit having a first input, a second input and an output, the first input of the adding circuit coupled to the power output terminal configured to receive an output voltage feedback signal indicative of the output voltage, the second input of the adding circuit configured to receive an output current feedback signal indicative of an output current of the switching circuit, and the adding circuit configured to add the output voltage feedback signal into the output current feedback signal and provide a combined feedback signal at the output of the adding circuit;
a comparing circuit having a first input, a second input and an output, the first input of the comparing circuit coupled to the output of the adding circuit configured to receive the combined feedback signal, the second input of the comparing circuit configured to receive a reference signal, and the comparing circuit configured to compare the combined feedback signal with the reference signal and provide a comparing signal at the output of the comparing circuit; and
a logic circuit having an input and an output, the input of the logic circuit coupled to the output of the comparing circuit configured to receive the comparing signal, the output of the logic circuit is coupled to the switching circuit configured to turn ON and OFF of the switch.

14. The control circuit of claim 13, further comprising a DC correction circuit, wherein:
the DC correction circuit has an input and an output, wherein the input of the DC correction circuit is coupled to the power output terminal configured to receive the output voltage feedback signal, and the output of the DC correction circuit is configured to provide the reference signal, wherein the reference signal is obtained by calculating the integral of the output voltage feedback signal and then filtering the integral; and
the adding circuit further has a third input, wherein the third input of the adding circuit is configured to receive a slope signal, the adding circuit configured to add the output voltage feedback signal, the output current feedback signal and the slope signal together and provide a combined feedback signal at the output of the adding circuit.

15. The control circuit of claim 14, wherein the DC correction circuit comprises:
a trans-conductance amplifier having a first input, a second input and an output, wherein the first input of the trans-conductance amplifier is configured to receive the output voltage feedback signal and the second input of the trans-conductance amplifier is coupled to a reference voltage; and
a compensation circuit comprising a capacitor and a resistor coupled in series, wherein a first end of the compensation circuit is coupled to a reference ground, and the other end of the compensation circuit is coupled to the output of the trans-conductance amplifier, and wherein the output of the trans-conductance amplifier is configured to provide the reference signal.

16. The control circuit of claim 13, further comprising:
a driving circuit having an input and an output, wherein the input of the driving circuit is coupled to the output of the logic circuit, and the output of the driving circuit is coupled to a control end of the switch configured to control ON and OFF of the switch; and
an output voltage feedback circuit comprising:
a first resistor having a first end and a second end, wherein the first end of the first resistor is coupled to the power output terminal; and
a second resistor having a first input and a second input, wherein the first input of the second resistor is coupled to the second end of the first resistor, the second end of the second resistor is coupled to a reference ground and the second end of the first resistor is configured to provide the output voltage feedback signal.

17. The control circuit of claim 13, wherein the logic circuit comprises:
a clock signal generator configured to generate a clock signal; and
a flip latch having a first input, a second input and an output, wherein the first input of the flip latch is coupled to the clock signal generator configured to receive the clock signal, the second input of the flip latch is coupled to the output of the comparing circuit configured to receive the comparing signal, and the output of the flip latch is configured to control ON and OFF of the switch.

18. The control circuit of claim 17, further comprising a slope signal generator configured to provide a slope signal, wherein the slope signal is configured to have a same frequency with the clock signal.

19. A transient response control method of controlling a switch in a SMPS, the method comprising:
detecting an output voltage of the SMPS to obtain an output voltage feedback signal;
detecting an output current of the SMPS to obtain an output current feedback signal;
adding the output voltage feedback signal into the output current feedback signal to obtain a combined feedback signal;
comparing the combined feedback signal to a reference signal to obtain a comparing signal; and
turning ON and OFF the switch according to the comparing signal.

20. The method of claim 19, further comprising adding a slope signal together with the output voltage feedback signal and the output current feedback signal to obtain the combined feedback signal, and wherein the reference signal is obtained by calculating the integral of the output voltage feedback signal based on a period of time and then filtering the calculated integral.
